(19) United States
(12) Patent Application Publication
(10) Pub. No.: US 2003/0074435 A1
(43) Pub. Date: Apr. 17, 2003

(54) Smart business manager postal calculator

(76) Inventor: George Bradley Hobbs, Caldwell, ID (US)

Correspondence Address: HEWLETT-PACKARD COMPANY, Intellectual Property Administration, P.O. Box 272400, Fort Collins, CO, 80527-2400, US

(21) Appl. No.: 09/976,704

(22) Filed: Oct. 11, 2001

(51) Int. Cl. G06F 9/44; G06F 15/173

(52) U.S. Cl. 709/223; 709/317

(57) ABSTRACT

A system and method for predicting the postage for the mailing of a physical hardcopy of a print job or print job. The print job includes a series of attributes that define the characteristics of the hardcopy, these characteristics are used to calculate the weight and size of the print job and then a postage rate scale for the carrier is applied to determine the postage, or shipping cost. The calculated postage is printed on the appropriate portion of the hardcopy of the print job. Postage or shipping cost is automatically billed to an account.

### TECHNICAL FIELD

The invention relates generally to calculating postage, and more particularly to a system and method for calculating the postage costs associated with mailing a printed document.

### BACKGOUND OF THE INVENTION

Computer users today are able to generate sophisticated documents that may be suitable for a variety of high-end printers employing different printing technologies. Often hardcopies of sophisticated documents are distributed by mail, such as in direct mail advertisements. The postage or shipping cost associated with mailing documents printed with different printer technology, media type, and formatting options is largely unknown prior to weighing a hardcopy of the document. It would be desirable to be able to accurately estimate the postage prior to printing hardcopies of the print job. The estimated postage can then be printed on the appropriate portion of each of the hardcopies at the time of printing reducing the number of steps in preparing the document for mailing.

### SUMMARY OF THE INVENTION

The present invention provides a method and a system for predicting the postage for mailing a physical hardcopy of a print job. The print job includes a set of attributes that define the hardcopy. These attributes may be used to calculate the weight and size of the print job before applying a postage rate scale for the chosen carrier to determine the postage, or shipping cost. The calculated postage then may be printed on an appropriate portion of the hardcopy. Postage or shipping cost thereafter may be automatically billed to an account.

### BRIEF DESCRIPTION OF THE DRAWINGS

FIG. 1 is a networked computer system in which one embodiment of the present invention may be implemented.

FIG. 2 is a schematic depiction of a computer in the networked system of FIG. 1.

FIG. 3 is a graphical user interface of one embodiment of the present invention.

FIG. 4 is a flow chart of a method for calculating postage for a print job prior to creating the physical hardcopy.

### DETAILED DESCRIPTION OF THE INVENTION

The present invention provides a method and system for calculating the postage cost for mailing an electronic print job and displaying that cost to a user, prior to producing a hardcopy, printing the calculated postage in an appropriate location on the print job, and automatically billing the postage amount to an account.

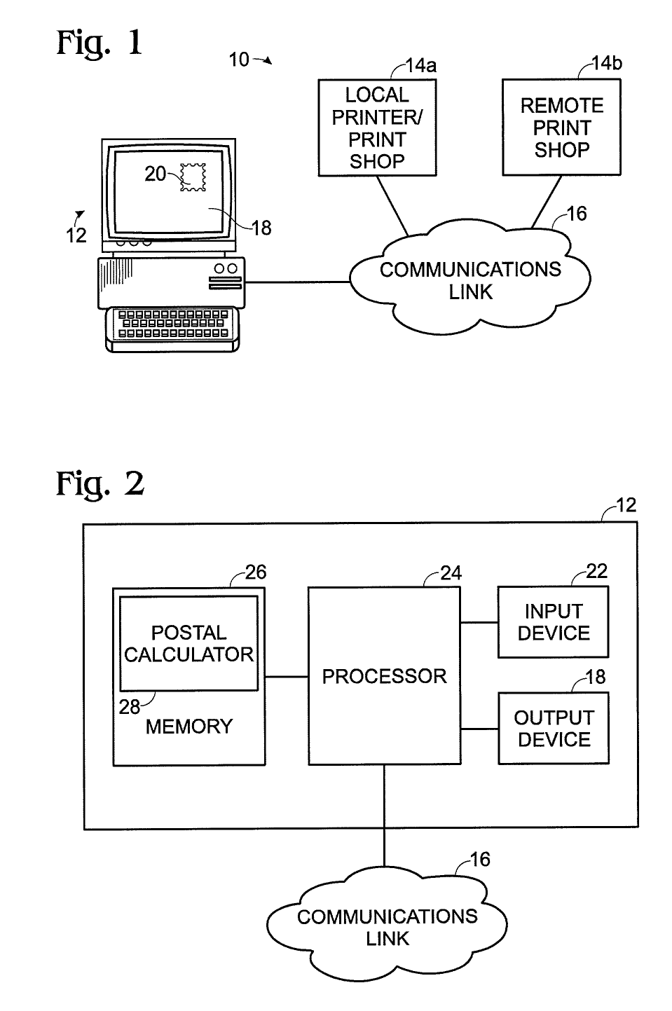

A network system 10 for carrying out the present invention is shown in FIG. 1. The network system includes a computer 12, a local print shop 14a, a remote print shop 14b, and a communications link 16. In accordance with the present invention the depicted network system uses computer 12 to evaluate an electronic print job to calculate postage costs. The electronic print job may be created in an application on computer 12.

Computer 12 may have a display monitor 18 that includes icons representing applications that are configured to run on computer 12. A postal calculator icon 20 is displayed on display monitor 18 in the depicted embodiment. When a user selects icon 20, computer 12 executes the method of the present invention, as will be explained below.

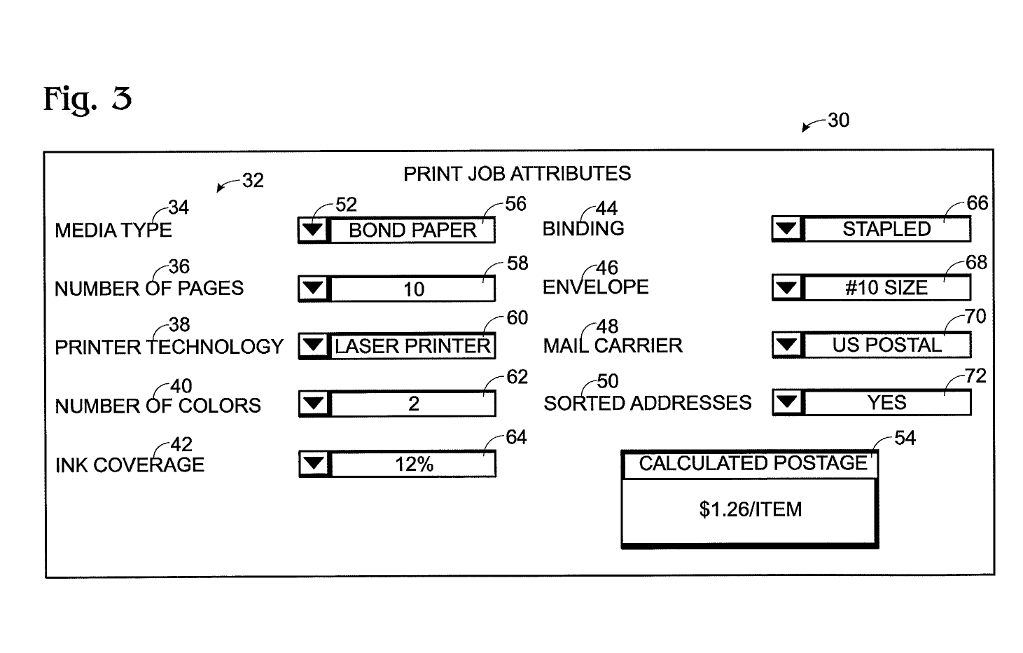

FIG. 2, shows, in more detail, how computer 12 of network system 10 may be configured. In this example, computer 12 includes an output device 18, an input device 22, a processor 24, a communications link 16, and memory 26. A postal calculator 28 is stored on memory 26, and is configured to run on processor 24, interacting with input device 22, output device 18, and communications link 16. Other suitable devices may be used according to the present invention, including but not limited to personal digital assistants, handheld computers, cell phones, laptop computers, etc.

Communications link 16 is any set of connections that allows communication between computer 12 and a printer or print shop. The communications link may be configured as a local area network, for example, a network within an office or company. Alternatively, the communications link may be a global communications network, such as the Internet. In yet another example, communications link 16 may be a direct dial up connection. Additionally, communications link 16 may be a wireless network, or an integrated wireless and wired network. Any suitable computer communications technology presently known, or in the future developed, is within the scope of communications link 16.

Print shop 14a is shown as a local print shop, which may take the form of an on-site print shop, or represent on-site printing capabilities. Print shop 14b is shown as a remote print shop, which may take the form of an off-site print shop, offering full-service printing capabilities.

As noted above, user-selection of icon 20 causes processor 24 to execute postal calculator 28. Upon such execution, in the depicted embodiment, postal calculator 28 displays a screen 30 to a user on output 18, showing the user all the attributes of the print job, as shown in FIG. 3. It should be noted that postal calculator 28 need not present a visual display to the user via output 18.

An attribute headings list 32 of user-selectable print job attributes may be displayed on screen 30. Exemplary, headings list 32 includes “Media Type” heading 34, “Number of Pages” heading 36, “Printer Technology” heading 38, “Number of Colors” heading 40, “Ink Coverage” heading 42, “Binding” heading 44, “Envelope” heading 46, “Mail Carrier” heading 48, and “Sorted Addresses” heading 50. Adjacent each attribute heading is a selected attribute.

In the depicted embodiment, “Media Type” heading 34 is displayed adjacent a corresponding media type attribute 56, which may be configured to display the type of media a hardcopy is to be printed on. For example, media type attribute 56 shows as “bond paper” in FIG. 3. Similarly, “Number of Pages” heading 36 is displayed adjacent the number-of-pages attribute 58, which shows the number of pages in the print job. The number of pages of a print job may be entered by the user, or determined automatically by the application or postal calculator.

In the same manner, “Printer Technology” heading 38 is displayed adjacent the printer technology attribute 60, which identifies the type of printer or printing technology that will be used in the print job. Printer technology attribute 60, for example, may be a laser printer, a black and white ink jet, color ink jet, or any other style printer.

Likewise, “Number of Colors” heading 40 is displayed adjacent the number of colors attribute 62. Number of colors attribute 62 displays the number of colors that will be used in the print job. “Ink Coverage” heading 42 is displayed adjacent the ink coverage attribute 64. Ink coverage attribute 64 may be configured to display the percentage of ink coverage for a given area. It should be understood that, while the depicted embodiment shows the ink coverage attribute as a percentage, it may also be in dots per inch or any other suitable units of measure. “Binding” heading 44 is displayed adjacent the binding attribute 66. Binding attribute 66 may be configured to display the type of binding that will be used in the print job. For example, with a hardcopy may be bound by staples, spiral binding, cloth binding, etc. “Envelope” heading 46 is displayed adjacent envelope attribute 68. Envelope attribute 68 may be configured to display the type of envelope in which the print job will be mailed. For example, the print job may be mailed in a letter size envelope, legal size envelope, #10 size envelope, etc. “Mail Carrier” heading 48 is displayed adjacent the mail carrier attribute 70. Mail carrier attribute 70 may be configured to indicate what carrier or shipping service will be used for the print job. For example, the mail carrier may be the United States Postal Service, Federal Express, United Parcel Service, or similar delivery carriers. “Sorted Addresses” heading 50 is displayed adjacent the sorted addresses attribute 72. Sorted addresses attribute 72 maybe configured to provide a Boolean yes or no, to indicate whether or not the addresses to which the print job will be sent are sorted by zip code.

Typically, each print job contains a set of predefined attributes. However, attributes may be set by default, or selected by a user. Postal calculator 28, for example, may be configured such that adjacent each of the job attributes is a pull down menu, as indicated at 52, for user selection of the attributes of the print job.

In accordance with the invention, a calculated postage 54 may be determined using the attributes of the print job. The first step in calculating postage for a print job is to determine the weight of a to-be-printed hardcopy. As will be appreciated upon reading further, the weight of a hardcopy may be determined using information from the above-described attributes of the corresponding print job.

Media-type attribute 56, printer-technology attribute 60, number-of-colors attribute 62, ink-coverage attribute 64, binding attribute 66, envelope attribute 68, and mail-carrier” attribute 70, are each associated with a database for the respective attribute. Each database stores the relevant information about each attribute for use in calculation of the weight of the hardcopy. For example, the database associated with media types attribute 56 may include unit weight, unit cost, durability rating, conflict warnings, and other useful data.

Conflict warnings may include limitations of each type of media. For example, transparency media may not be compatible with certain printer technologies (e.g. laser printing). Conflict information may be stored in the database associated with media types attribute and cross-referenced with the printer technology attribute database. If conflicts occur between attributes a possible attribute selection may be grayed out (not shown), thus preventing the selection of conflicting attributes.

The database associated with “Printer Technology” heading 38 includes information relating to printing technology. Such information may include, ink weights, coverage ranges, as well as conflict warnings, and other information for each available printer technology. Various printer technologies deposit different amounts of ink (or toner) and various inks (and toners) have different densities. By way of example, some of the variation in ink weight is illustrated in the table below:

| | Calculated Consumable Usage (grams) | | | | | |
|---|---|---|---|---|---|---|
| | | | | | Total | |
| Product | C | M | Y | K | Ink | Oil |
| Indigo | 0.082 | 0.092 | 0.075 | 0.065 | 0.314 | 0.775 |
| TurboStream ® | | | | | | |
| Canon CLC | xxx | xxx | xxx | xxx | 0.270 | 0.030 |
| 1000 ® | | | | | | |
| HP Laserjet | 0.042 | 0.033 | 0.065 | 0.070 | 0.210 | 0.000 |
| 4500 ® | | | | | | |
| HP 2000C ® | 0.077 | 0.065 | 0.050 | 0.2 | 0.392 | 0.000 |

The above ink weights are stored in the database associated with printer technology attribute, and may be used to determine the weight of the hardcopy of the print job prior to printing.

In a similar manner, databases for the other attributes mentioned above may contain information related to the weight of the print job or postal rate for mailing or shipping the print job. Any attribute that affects the weight potentially impacts on postage costs. Generally these are attributes that add mass to the hardcopy. For example, number of pages provides a multiplier for the unit weight of a page. The unit weight of the page would be information known for each media type. Similarly, heavier inks and more dense ink coverage areas increase the weight of the print job. These factors are used to calculate a predicted weight, and may be referred to as weight-determining factors.

Note, not all attributes need have a database of information associated therewith. Number of pages attribute 58 may not link to a database. Rather, this attribute may simply be a number that becomes a multiplier for determining overall weight (e.g. number of sheets multiplied by the weight of each sheet gives the weight before adding binding and envelope weights). Similarly, sorted Addresses attribute 72 may define a “yes” or “no” attribute, and thus no database is needed.

After determining an estimated weight for the hardcopy of the print job, postal calculator 28 determines a postal rate scale to be applied to the print job. Several attributes affect the postal or shipping rate scale that is used for calculating the cost of shipping a print job of any given weight. The database associated with mail carrier attribute 70 includes various available mail carriers. The selected carrier is the primary factor in determining what postal or shipping rate scale will be used. Irregular size items are sometimes charged at a higher rate so attributes affecting size may be considered when determining the postal or shipping rate scale. Attributes affecting size may be referred to as size-determining factors. Postal calculator 28 determines a parcel size based on the attributes affecting size. Overnight and other priority shipping, or delivery methods are charged at higher rates, so attributes effecting delivery speed may also be considered. After considering all relevant non-weight factors a rate scale is determined and postage is calculated. Once the postage is calculated it is displayed and incorporated into the print job. Postal calculator 28 prints the postage on the print job at the time of printing.

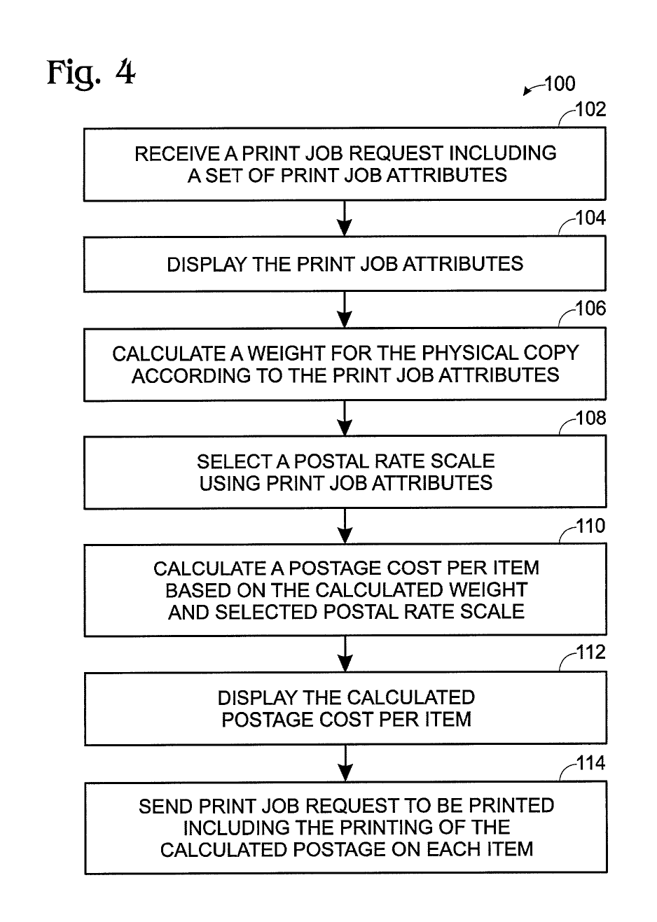

The method executed by postal calculator 28 is shown in FIG. 4, generally indicated at 100. Postal calculator 28 receives a print job request. The print job request includes a set of print job attributes as indicated at 102. Postal calculator 28 displays the set of print job attributes via output 18 at 104. The attributes include, but are not limited to, media-type attribute 56, number-of-pages attribute 58, printer-technology attribute 60, number-of-colors attribute 62, ink-coverage attribute 64, binding attribute 66, envelope attribute 68, mail-carrier attribute 70, and sorted-addresses 72. Postal calculator 28 calculates an estimated weight for the physical hardcopy according to the print job attributes. The weight typically is calculated using all the attributes that contribute to weight, at 106. Postal calculator 28 selects a postal or shipping rate scale using the print job attributes. The postal rate scale may be based on the selected carrier, the time allowed for delivery, the size of the physical hard copy, and other rate-determining factors, such as whether or not the addresses are sorted by zip code, as indicated at 108. Postal calculator 28 calculates a postage-per-item mailed by applying the selected postage rate scale to the calculated weight of the print job, at 110. The postal calculator then displays the calculated postage on a per-item basis to output 18, and records the per item postage in the print job, at 112. Finally, at 114, postal calculator 28 sends the print job request to be printed. The print job includes printing the calculated postage on each item in an appropriate location for shipping or mailing. Typically, the postage is printed in the upper right hand comer of an envelope. If there is no envelope, the postage is printed on another appropriate position on the hardcopy or on a label to be applied to the hardcopy. The total cost of mailing the printed copies of the print job may be automatically billed to a user's account.

While the present invention has been particularly shown and described with reference to the foregoing preferred embodiments, those skilled in the art will understand that many variations may be made therein without departing from the spirit and scope of the invention as defined in the following claims. The description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring nor excluding two or more such elements.

I claim:

1. A computer-implemented method for calculating the postage of a print job, the method comprising the steps of:
providing an electronic print job having a set of predefined electronic printjob attributes; and
calculating a postage for the print job using the set of predefined electronic print job attributes.

2. The method of claim 1, wherein calculating a postage for the print job includes calculating a weight for the print job using weight-determining factors from the set of predefined electronic print job attributes and applying a postage rate scale associated with the calculated weight.

3. The method of claim 2, wherein calculating a postage for the print job further includes determining a parcel size for the print job using size-determining factors from the set of predefined electronic print job attributes and applying a postage rate scale associated with the determined parcel size.

4. The method of claim 3, wherein calculating a postage for the print job further includes:
determining a delivery method using the predefined electronic print job attributes and applying a postage rate scale associated with the determined delivery method; and
calculating postage from the calculated weight, shipping size, and postage rate scale applied.

5. The method of claim 4, wherein the weight-determining factors are selected from the group consisting of media type, printer technology, number of pages per item mailed, and binding materials.

6. The method of claim 4, wherein the determined delivery method defines a carrier.

7. The method of claim 4, wherein the determined delivery method defines a service type.

8. The method of claim 4, wherein the parcel size is determined automatically using media type, number of pages, and binding materials.

9. The method of claim 4, wherein the parcel size predetermined by a user.

10. The method of claim 1, wherein the calculated postage is forwarded to a print shop to be printed along with the hardcopy.

11. A postal calculator comprising a storage medium having a plurality of machine-readable instructions, wherein when the instructions are executed by a computing system, the instructions provide for the steps of:
providing an electronic print job having a set of predefined electronic printjob attributes; and
calculating a postage for the print job using the set of predefined electronic print job attributes.

12. The postal calculator of claim 11, wherein calculating a postage for the print job includes calculating a weight for the print job using weight-determining factors from the set of predefined electronic print job attributes and applying a postage rate scale associated with the calculated weight.

13. The postal calculator of claim 12, wherein calculating a postage for the print job further includes determining a parcel size for the print job using size-determining factors from the set of predefined electronic print job attributes and applying a postage rate scale associated with the determined parcel size.

14. The postal calculator of claim 13, wherein calculating a postage for the print job further includes:
determining a delivery method using the predefined electronic print job attributes and applying a postage rate scale associated with the determined carrier; and
calculating postage from the calculated weight, parcel size, and postage rate scale applied.
